(19) United States
(12) Patent Application Publication
(10) Pub. No.: US 2010/0010881 A1
(43) Pub. Date: Jan. 14, 2010

(54) Using a Conflict of Interest Method and System with Regression Analysis for Analyzing Portfolio Manager Performance

(76) Inventor: William Chen, Rowland Heights, CA (US)

Correspondence Address: William Chen, 28130 Peacock Ridge Drive, #310, Rancho Palos Verdes, CA, 90275, US

(21) Appl. No.: 12/172,239

(22) Filed: Jul. 13, 2008

(51) Int. Cl. G06Q 10/00; G06Q 40/00

(52) U.S. Cl. 705/11

(57) ABSTRACT

To analyze the factors that contribute to the performance of the portfolio manager has always been a challenging task. Traditionally, the background of the manager, statistical data associated with the manager, and many tangible and intangible considerations play a role in the evaluation of the manager. A portfolio manager can not operate without the supporting teams; the manager is also influenced by the operational environment and a changing market structure. For this invention, the conflict of interest method is utilized to characterize the operational environment and the market structure that have been missing from traditional evaluation method of the manager. The objective of this invention is to introduce a balanced method for evaluating the portfolio manager by analyzing the investment process and its components that the manager has to work with it. By building the COIS into regression analysis, the contributing factors of performance are extended from factors associate with the manager to include factors related to the market participants, investment process, business practice, operational environment and market structure. The COI Method opens new paths to perform analysis and decision making in many fields of investment.

### CROSS-REFERENCE TO RELATED APPLICATIONS

Application Ser. No. 12/111,964: The conflict of interest method and system for selecting investment manager and investment processes.

### BACKGROUND OF THE INVENTION

To analyze the factors that contribute to the performance of a portfolio manager has always been a challenging task. Traditionally, the background of a manager, statistical data associated with the manager, and many tangible and intangible considerations play a role in the evaluation of a manager.

A portfolio manager can not operate without the supporting team members who include researchers, traders, broker-dealers and the market infrastructure. The manager's performance is also influenced by the operational environment and a changing market structure. If the evaluation is focused on a manager without examining the surrounding environment, we are looking at an incomplete picture.

### BRIEF SUMMARY OF THE INVENTION

The conflict of interest method has been introduced in the patent application Ser. No. 12/111,964 which is utilized to characterize the operational environment and the market structure that have been missing from the traditional evaluation method of a manager. The objective of this invention is to introduce a balanced method for evaluating the portfolio manager by analyzing the COI (Conflict of Interest) risk associated with the investment process and its components that the manager has to work with it. This method will help to identify the contributing factors of the performance of the manager.

In general, in one aspect, the invention features a method for study the contributing factors to the performance of the manager based on the level of potential for COI that is associated with the investment process and its components in addition to the traditional factors. The COI has its origin in the interactions among market participants, business arrangement and practice, operational environment, market structure and other relevant factors.

At the core of the COI method, it is the Conflict of Interest Score (COIS). The COIS is determined by a qualitative assessment of potential level of conflict of interest for the relevant factors associate with the components of investment process. The components include client (investor), research, investment manager, trader, broker-dealer, dark pool, exchange and regulatory agency. The relevant factors include the background of the client, interaction among market participants, business arrangements and practices, operational environment, market structure, rules, regulation and all other related considerations. The result of the qualitative assessment is expressed in term of low, medium or high potential of conflict of interest, which is assigned a numerical value of 1, 2 or 3, respectively. The numerical value is the COIS for the relevant factor under analysis. The COIS is cumulative. The COIS is compiled into a COIS Assignment Matrix (COISAM).

The COIS Assignment Matrix is comprised of two parts. The first part, column 1, includes the relevant factors associated with the components of the investment process. The second part, column 2, is the COIS corresponding to the relevant factor in column 1.

Collecting inputs according to an Input Check List (ICL) which comprises the COISAM and Manager Related Data (MRD). Selecting the appropriate situations as described in the Column 1 of the COIS Assignment Matrix, corresponding COIS are selected from the column 2. Summation over the selected COIS produces an Overall COIS for the investment process implemented by the manager. This step is repeated for each portfolio manager under evaluation.

Use the Overall COIS and MRD from each manager to populate the ICL Database.

The COI method provides a new framework for analyzing investment related issues. One of the applications is to identify the contributing factors to the manager's performance.

In general, in another aspect, the invention features a system for study contributing factors to the performance of the manager. It includes a user interface to create the database and to enter database query to retrieve the output of the processor; a memory to store the database created by combing the Overall COIS with manager related data; and a processor to process the end user inquiry based on asset allocation policy and requirements.

The advantage of the present invention is that all the relevant factors that impacts the performance of the manager that are essential but neglected in the past become the focus points in the COI approach. This method provides a balanced analysis and evaluation of the entire investment process and its components that have direct influence on the manager. The COI method has great flexibility to include as many factors, variables and details as needed for a dynamic environment.

The details of one or more embodiments of the invention are set forth in the description below. Other applications, features, objects, and advantages of the invention will be apparent from the description and from the claims.

### BRIEF DESCRIPTION OF THE SEVERAL VIEWS OF THE DRAWING

Not Applicable

### DETAILED DESCRIPTION OF THE INVENTION

To analyze the factors that contribute to the performance of the portfolio manager has always been a challenging task. Traditionally, the background of the manager, statistical data associated with the manager, and many tangible and intangible considerations play a role in the evaluation of the manager. A portfolio manager can not exist without the supporting team members. The manager's performance is also influenced by the operational environment and a changing market structure. If the evaluation is focused on the manager without examining the surrounding environment, we are looking at half of the picture.

The conflict of interest method is utilized to characterize the operational environment and the market structure that have been missing from traditional evaluation method of the manager. The objective of this invention is to introduce a balanced method for evaluating the portfolio manager by analyzing the COI risk associated with the investment process and its components that the manager has to work with. This method will help to identify the contributing factors of the performance of a manager.

Overview: Using the COI Method with regression technique for evaluating the contributing factors to the portfolio manager's performance.

Part I. Preliminary:
Step 001: Derivation of the Conflict of Interest Score (COIS) for relevant factors associated with the market participants and infrastructure.
Step 002: The results of Step 001 are compiled into COIS Assignment Matrix (COISAM).
Step 003: Defining Input Check List Database which will store the Overall COIS and MRD for each manager.
Step 004: Creating Input Check List (ICL) which comprises COIS Assignment Matrix and Manager Related Data (MRD).

Part II. To populate the ICL Database, step 100 to step 300 are repeated for each investment manager under evaluation.
Step 100: Base on Input Check List, collect inputs and select appropriate COI Score (COIS) for each input.
Step 200: The summation of the selected COIS from Step 100 generates an Overall COIS associate with the entire investment process and the portfolio manager.
Step 300: Enter Overall COIS and MRD for each portfolio manager into the ICL database.

Part III. Applications

With the help of regression analysis, a detail study of the contributing factors to the performance of the manager becomes possible. By building the COIS into regression analysis, the contributing factors are extended from factors associate with the manager to include factors related to the market participants, investment process, business practice, operational environment and market structure.

Part I. Preliminary:

Step 001: Derivation of the COIS is accomplished by performing qualitative analysis of relevant factors associated with the investment process and its components in term of potential level of conflict of interest (COI).The investment process and its components include, but are not limited to the following: client, research report, manager, trader, Broker-Dealer (BD), dark pool and exchanges. The relevant factors include, but not limited to the following: the background of the client, interaction among market participants, business arrangement and practice, operational environment, market structure, rule and regulation, and all other related factors.

The qualitative assessment includes the evaluation of all relevant factors associated with the components. The assessment is based on the nature and characteristics of the factor; it's interaction with other relevant factors, in conjunction with public and private information and knowledge regarding the compliance issues, illegal practices and current litigations in the court system.

The result of analysis determines the potential level of COI for the relevant factor. The three levels of potential of conflict of interest are low, medium and high; and are assigned a numerical value of 1, 2 and 3, respectively. The numerical value is the Conflict of interest Score (COIS) for the relevant factor under analysis. The COIS is cumulative. The number of levels for COI in this method can be expanded depending on the complexity of the method required.

The COI method is intended for the benefit and protection of the general investor. The spirit of fiduciary responsibility and ethical business practices should be exercised when working with the COI method. The COI Method is not intended to be used as a marketing tool.

Derivation of COIS for the Client of the Investment Manager

Knowledge and experience of the client are the two factors used in the determination of COIS for client. Sufficient amount of knowledge and experience in the area of investment process and illegal industry practices will reduce predatory practices against the client which leads to lower potential for conflict of interest. The COIS for the client is determined base on the evaluation of the following criteria.
a. Client does not have NASD S/24 qualification or equivalent knowledge, the potential level of COI is high; COIS: 3.
b. Client has S124 qualification or equivalent knowledge or understands the investment process and the industries illegal and questionable practices. The potential COI is medium; COIS: 2.
c. Client has implemented monitoring program to identify illegal practices and compliance problems associate with financial service providers. The potential COI is low; COIS: 1.

Derivation of COIS for the Research

Depending on the origin of the research report, and number of users sharing the report, the potential level of COI is determined as follows:
a. Independent in-house research reports, dedicated to one user, represents low potential for COI; COIS: 1.
b. Purchase research report from independent research firm or there are multiple user of the research report; COIS: 2.
c. Research report is provided by Broker/Dealer who is a potential competitor with inherent conflict of interest, motivation behinds the report is uncertain, the potential COI is high; COIS: 3.
d. If multiple research sources are used, select the one with the highest COIS for this section.

Derivation of COIS for the Investment Manager

The factors used for determining COIS for the Investment manager are: manager's organization structure, business arrangement and practice. Additional information for manager is collected according to the Manager Related Data (MRD) in ICL. The COIS for investment manager is cumulative.
a. For investment manager who is independent from any other organization, the potential for COI is low; COIS: 1.
b. For manager who is part of a Broker-Dealer (BD) organization, works with multiple clients, shares resources such as research and trading staff, the potential for COI is medium; COIS: 2.
c. For manager who has a soft dollar arrangement with Broker/dealer, the potential for COI is high; COIS: 3.
d. For manager uses fundamental analysis only and does not perform timing analysis; COIS: 3.

Derivation of COIS for the Trader

The years of trading experience of the trader and the availability of trading tools are the factors in evaluation of COIS.
a. For simplicity, if majority of the traders in the trading department have more than 8 years of experience, COIS: 1. If majority of the traders have less than or equal to 8 years but greater than 3 years of experience, COIS: 2. If majority of the traders have less than or equal to 3 years of experience, COIS: 3.
b. For trading department without transaction analysis program in place, ability to detect transaction types of problem is weakened, COIS: 3, otherwise, COIS: 1.
c. For trading department not using an iceberg facility, the ability to hide the order is reduced, COIS: 3, otherwise, COIS: 1.

Derivation of COIS for the Broker/Dealer (BD)

The BD is one of the most significant participants in the investment process. There are many factors in evaluation of COIS for Broker-Dealer, the total COIS for BD is the accumulation of all the COIS associates with the applicable factors.
a. Order execution:
   If an order is executed against the B/D's own inventory, this represents a direct competition between the BD and the client; COIS: 2.
   If BD performs internal matching of order, this may not be a best execution; COIS: 2.
   If both methods are used; COIS: 2.
b. BD Owns investment fund, a competitor; COIS: 1.
c. BD Owns Asset Management firm, a competitor; COIS: 1.
d. For a BD that has proprietary trading department, this is a direct competitor to the client's interest, with potential for information leakage; COIS: 3.
e. For a BD that has the Specialist unit on the exchange, a direct competitor to the client with the power of setting opening price, short sell and holding demand/supply information; COIS: 3.
f. For a BD that engages in IPOs, the COIS will be evaluated base on past performance of IPO over the last three year period. For simplicity, at the time of evaluation, if >75% of IPO remains above offering price, COIS: 1; if >50% but <=75% of the IPO remains above offering price, COIS: 2; if <=50% of the IPO remains above offering price, COIS: 3.

Infrastructure Related Issues:

Derivation of COIS for the Dark Pool

The COIS will vary depending on the destination of order execution. There are many factors impacting the potential level of COI for the dark pool, including the user profile of the pool, liquidity, information leakage, pricing and rebate structure and BD algorithm access. For simplicity, assume the liquidity requirement is meet, the COIS evaluation is based on user profile and potential for information leakage; if multiple dark pools are used, select the one with the highest COIS.
a. There are two types of independent dark pools:
   Buy side participants only, mainly consists of institution investors, represents the low potential for COI; COIS: 1.
   Buy and sell side participants, sell side mainly consists investment banker and BD, in competition with the buy side participants; COIS: 2.
b. Consortium-Owned Dark Pools; COIS: 2.
c. Broker-Dealer-Owned Dark Pools: COIS: 2.
d. Exchange-Owned Dark Pools; COIS: 2.

Derivation of COIS for the Exchanges

If the order is executed on the exchanges:
a. Low touch, fully automated system; COIS: 1.
b. High touch, specialist involved system; COIS: 3.
c. If both systems are used; COIS: 3.

The components of the investment process and relevant factors will change over time due to both internal and external forces. Recent restructuring of regulatory agencies will also impact the COI level over the long term, the COIS will need to be adjusted to reflect the new reality and conditions. For a more in depth analysis of each of the components, additional factors could be introduced. Since the COIS is cumulative, additional factors will increase the Overall COIS for the investment process. A Component Multiplier could be used to adjust the level of conflict of interest at component level.

Due to the implementation of National Market System (NMS), some of the COIS will need to be modified depending on the degree of success of NMS implementation. The regulatory agencies and court system have significant impact on the COI method on a macro level, stringent rules and regulations with aggressive enforcement will result in a lower level of COIS in general.

Step 002: The COIS are compiled into the COIS Assignment Matrix.

The Conflict of Interest Score Assignment Matrix (COISAM) includes two parts; column 1 represents the relevant factors associate with the components of the investment process. The second part, column 2, is the COIS corresponding to the relevant factor in column 1.

COIS Assignment Matrix:

| Column 1 | |
|---|---|
| Component of Investment Process | Column 2 |
| And Relevant Factors | COIS |
| Client | |
| a. Client does not have NASD S/24 qualification or equivalent knowledge. | 3 |
| b. Client has NASD S/24 qualification or equivalent knowledge or understands | 2 |
| the investment process and industries illegal and questionable practices. | |
| c. Client has implemented a monitoring program to identify illegal practices and | 1 |
| compliance problems associated with the financial service providers. | |
| Research | |
| a. Independent in-house research reports, dedicated to one user | 1 |
| b. Purchase research reports from independent research firms or the research | 2 |
| report is used by multiple users | |
| c. Research report is provided by Broker/Dealer | 3 |
| Investment Manager | |
| a. For investment manager who is independent from any other organization | 1 |
| b. For manager who is part of Broker-Dealer (BD) organization | 2 |
| c. For manager who has soft dollar arrangement with Broker/dealer | 3 |
| d. For manager uses fundamental analysis only and does not perform timing | 3 |
| analysis | |
| Trader | |
| If majority of the traders have more than 8 years of trading experience | 1 |
| If majority of the traders have less than or equal to 8 years but greater than 3 | 2 |
| years of trading experience | |
| If majority of the traders have less than or equal to 3 years of trading experience | 3 |
| For trading department: | 3 |
| a. For trading department without transaction analysis program in place | |
| otherwise, COIS is: | 1 |
| b. For trading department without using iceberg facility | 3 |
| otherwise, COIS is: | 1 |
| Broker/Dealer (BD) | |
| a. Order execution | |
| If order is executed against B/D own inventory | 2 |
| If BD performs internal matching of order | 2 |
| If both methods are used | 2 |
| b. BD Owns Investment Fund | 1 |
| c. BD Owns Asset Management | 1 |
| d. For BD has Proprietary trading department | 3 |
| e. For BD has the Specialist unit on the exchange | 3 |
| f. For BD engages in IPO, the COIS will be determined base on the performance | |
| over the past three years at the time of evaluation. | |
| if >75% of IPO remains above offering price | 1 |
| if >50% but <=75% of IPO remains above offering price | 2 |
| if <=50% of the IPO remains above offering price | 3 |
| A. Dark Pool | |
| If multiple dark pools are used, select the one with the highest COIS | |
| when computing Overall COIS. | |
| a. Independent Dark Pools, two types: | |
| Buy side participants only | 1 |
| Buy and sell side participants | 2 |
| b. Consortium-Owned Dark Pools | 2 |
| c. Broker-Dealer-Owned Dark Pools | 2 |
| d. Exchange-Owned Dark Pools | 2 |
| B. Exchanges | |
| If the order is executed on the exchanges: | |
| a. Low touch, full automated system | 1 |
| b. High touch, specialist involved system; | 3 |
| c. If both systems are used | 3 |

The COIS assignment matrix needs to be adjusted over time due to the evolution of the market structure, new ways of doing business, new exchange rules and regulations and increasing client experience and knowledge and other relevant factors.

Step 003, Define ICL Database Specification:

Each investment manager will have a record in the database. Each record is collected according to the Input Check List [0041]. The fields of the database are: Overall COIS, investment-objective, investment manager (IM) name, IM years of experience, years of education, asset under management (AUM), fund name, fund type, yield, portfolio turn-over rate, 1, 3, 5 and 10 years return data, volatility and market index consistent with the fund type.

Step 004: Input Check List includes COIS assignment matrix and Manager Related Data (MRD):
Part A: COIS Assignment Matrix
Part B: MRD, it includes the investment-objective, investment manager (IM) name, IM years of experience, years of education, asset under management (AUM), fund name, fund type, yield, portfolio turn-over rate, 1, 3, 5 and 10 years return data, volatility and market index consistent with the fund type.

Part II. To Populate the ICL Database:

To populate the database, the Step 100 to Step 300 is repeated for each investment manager.

Step 100: Using the Input Check List, collecting Inputs by identifying appropriate situation listed in column 1 and circle the correspondent COIS in column 2.

Input Check List

Part A: COIS Assignment Matrix

| | COIS |
|---|---|
| Client | |
| a. Client does not have NASD S/24 qualification or equivalent knowledge. | 3 |
| b. Client has NASD S/24 qualification or equivalent knowledge or understands | 2 |
| the investment process and industry illegal and questionable practices. | |
| c. Client has implemented monitoring program to identify illegal practices and | 1 |
| compliance problems associated with the financial service providers. | |
| Research | |
| a. Independent in-house research reports, dedicated to one user | 1 |
| b. Purchase research report from independent research firm or the research report | 2 |
| is used by multiple users. | |
| c. Research report is provided by Broker/Dealer | 3 |
| d. If multiple research sources are used, select the one with the highest COIS for | |
| this section. | |
| Investment Manager | |
| a. For Investment manager who is independent from any other Organization. | 1 |
| b. For manager who is part of Broker-Dealer (BD) organization | 2 |
| c. For manager who has soft dollar arrangement with Broker/dealer | 3 |
| d. For manager uses fundamental analysis only and does not perform timing | 3 |
| analysis | |
| Trader | |
| If majority of the traders have more than 8 years of experience | 1 |
| If majority of the traders have less than or equal to 8 years but greater than 3 | 2 |
| years of experience | |
| If majority of the traders have less than or equal to 3 years of experience | 3 |
| Trading Department | 3 |
| a. For trading department without transaction analysis program in place | |
| otherwise, COIS is: | 1 |
| b. For trading department not using an iceberg facility | 3 |
| otherwise, COIS is: | 1 |
| Broker/Dealer (BD) | |
| a. Order execution | |
| If order is executed against B/D own inventory | 2 |
| If BD performs internal matching of order | 2 |
| If both methods are used | 2 |
| b. BD Owns Investment Fund | 1 |
| c. BD Owns Asset Management | 1 |
| d. For BD has Proprietary trading department | 3 |
| e. For BD has the Specialist unit on the exchange | 3 |
| f. For BD engages in IPO, the COIS will be selected base on the past three | |
| years of performance at the time of evaluation. | |
| if >75% of IPO remains above offering price | 1 |
| if >50% but <=75% of IPO remains above offering price | 2 |
| if <=50% of the IPO remains above offering price | 3 |
| A. Dark Pool | |
| If multiple dark pools are used, select the one with the highest COIS | |
| when computing Overall COIS. | |
| a. Independent Dark Pools, two types | |
| Buy side participants only | 1 |
| Buy and sell side participants | 2 |
| b. Consortium-Owned Dark Pools | 2 |
| c. Broker-Dealer-Owned Dark Pools | 2 |
| d. Exchange-Owned Dark Pools | 2 |
| B. Exchanges | |
| If the order is executed on the exchanges: | |
| a. Low touch, fully automated system | 1 |
| b. High touch, specialist involved system | 3 |
| c. If both systems are used | 3 |

Part B: Manager Related Data (MRD),it includes the investment-objective, investment manager (IM) name, IM years of experience, years of education, asset under management (AUM), fund name, fund type, yield, portfolio turn-over rate, 1, 3, 5 and 10 years return data, volatility and market index consistent with the fund type.

### (End of Input Check List)

Step 200: The summation over all the selected COIS (circled) from Step 100 generates an Overall COIS for the investment process implemented by the investment manager under evaluation.

Step 300: Enter Overall COIS and MRD into ICL database according to the ICL Database specification.

Part III. Applications

The COI method provides a unique framework for analysis of risk involving conflict of interest in the fields of investment. It can be incorporated into existing products or services or in starting new fields of research and applications. The following applications are use to illustrate the procedure and potential benefits of this invention, there are vast numbers of possibilities in additional to what is illustrated here.

The Overall COIS values have a range of distribution due to the nature and characteristics of market participant and infrastructure. On the low end of the range, it indicates a low potential for COI. It also implies the manager is more independent. The degree of independent can be expressed as the inverse of the Overall COIS. For a manager at the high end of the Overall COIS distribution, there is higher potential for conflict of interest due to the interaction among market participant and infrastructure. It could also imply monopoly or oligopoly situations.

Application A: To evaluate if the regression coefficient of Asset Under Management (AUM) predicting Yield would differ across three categories of Overall COIS; which is divided into the lower ⅓, middle ⅓ and upper ⅓; or independent manager, medium complex manager and high complex manager, respectively. The variable Overall COIS is coded 1 for independent manager, 2 for medium complexity manager and 3 for high complexity manager.

The format of the data is arranged as follows for 15 fictional managers, consisting of 5 independent managers, 5 medium complexity managers and 5 high complexity managers. In practice, the database should include many more managers.

Database format:

| [Manager #] | [Coded Overall COIS] | [Yield] | [AUM] |
|---|---|---|---|
| 1 | 1 | a | b |
| 2 | 1 | c | d |
| 3 | 1 | e | f |
| 4 | 1 | g | h |
| 5 | 1 | i | J |
| 6 | 2 | k | l |
| 7 | 2 | m | n |
| 8 | 2 | o | p |
| 9 | 2 | q | r |
| 10 | 2 | s | t |
| 11 | 3 | u | v |
| 12 | 3 | w | x |
| 13 | 3 | y | z |
| 14 | 3 | a | b |
| 15 | 3 | c | d |

We analyze the data for each coded Overall COIS group separately using the regression analysis. The parameter estimates (coefficients) for each group of manager will suggest the impact of AUM on Yield under the conditions of three different level of Overall COIS, which represents a wide spectrum of factors that influence the managers. These factors include manager related data, and the components of the investment process that interact with the portfolio manager.

We would need to perform specific significance tests to be able to make claims about the differences among these regression coefficients.

Application B: To run a regression model and to test the statistical significance of a group of variables consisting of factors related to the manager and components of the investment process, we start by preparing the database that will be used as inputs to the regression model.

Suppose we want to predict the 3 years return, Y, of the manager from years of experience, Component COIS1 and Component COIS2; in which Component COIS1 is computed by combining COIS of research, investment manager and trader, and Component COIS2 is derived by combining COIS of broker-dealer, dark pool and exchange.

A database is constructed with the following fields:
[Manager][Y: 3 years return][Years of experience][Component COIS1][Component COIS2]

Regression analysis would be performed by using Y as dependent variable; Years of experience, Component COIS1 and Component COIS2 as independent variable.

The significant of the coefficients will help to identify the key elements in the investment process and the manager related factors that influences the performance of the manager.

Conflict of Interest method with regression analysis according to an embodiment of the present invention is constructed with an input and output devices, memory and processor. Software consists of operation system, spread sheet, regression analysis program and database application.

The spread sheet accepts inputs based on the Input Check list, summation over the COIS column provides the Overall COIS for the manager and the process; repeat this step for each manager.

The Overall COIS and the data from the MRD of Input Check List is entered into the database which is stored in the memory. The database is populated by repeating this step for each manager.

The input device is used to manage database and enter regression analysis commands.

Various modifications and alterations of this invention will be apparent to those skilled in the art without departing from the scope and spirit of this invention. This invention should not be restricted to that set forth herein for illustrative purposes only.

I claim:

1. A method for selecting investment manager and investment process comprises
qualitative assessment of the potential level of Conflict of Interest (COI) for relevant factors relating to the components of the investment process;
the relevant factors including the background of the client, interaction among market participants, business arrangement and practice, operational environment, market structure, rule, regulation and all other related considerations;
the components of the investment process including the client, research, investment manager, trader, broker-dealer, dark pool, exchange and regulatory agency, and all other related entities.

2. The method of claim 1, wherein the qualitative assessment of each relevant factor for potential of conflict of interest is based on the nature and characteristics of the factor, its interaction with other relevant factors, in conjunction with information and knowledge available on the compliance issues, illegal practices and litigations in the court system.

3. The method of claim 2, wherein each of all the relevant factors is assigned one of the three potential levels of conflict of interest: low, medium or high, representing by a numerical value of 1, 2 or 3, respectively; the numerical values representing the Conflict of Interest Score (COIS).

4. The method of claim 3, wherein the COIS for each of the relevant factors is compiled into a COIS Assignment Matrix (COISAM) consisting of two parts:
Part 1, column 1, grouping of relevant factors by the components of the investment process;
Part 2, column 2, consisting of the COIS corresponding to the relevant factor in the column 1.

5. The method of claim 4, further comprising Input Check List (ICL) which has two parts;
Part A: COISAM; and
Part B: Manager Related Data (MRD), consisting of the investment-objective, investment manager (IM) name, IM years of experience, asset under management (AUM), fund name, fund type, yield, portfolio turnover rate, 1, 3, 5 and 10 years return data, volatility and market index consistent with the fund type.

6. The method of claim 5, further comprising the steps of: collecting of the inputs; matching the inputs with the Column 1 of the COIS Assignment Matrix of the ICL and selecting the corresponding COIS from the column 2; these steps are repeated for each manager.

7. The method of claim 6, further comprising the summation of the selected COIS to generate an Overall COIS for the manager and related investment process; this summation operation is repeated for each manager under evaluation.

8. The method of claim 7, further comprising the ICL Database consisting of the Overall COIS and the manager related data (MRD); the ICL Database is populated by entering Overall COIS and MRD for each of the managers and related process under evaluation.

9. The method of claim 8, further comprising the investment manager and related process selection policy in term of Overall COIS, manager performance and other selection criteria listed in MRD; the policy is restated into database query language to obtain desire result.

10. The method of claim 9, further comprising of the following interpretation modules regarding the Overall COIS:
A. Overall COIS indicating the degree of independent of the manager and the complexity of the investment process, where degree of independent is expressed as the inverse of Overall COIS;
B. Maximum Overall COIS value indicating the need to implement a monitoring program to assure investment process integrity which will have direct impact on the performance of the investment;
C. Minimum Overall COIS indicating performance data is a reflection of the manager's investment ability due to minimum influence by the conflict of interest.

11. The method of claim 8, wherein the Overall COIS in divided into three groups based on its value, using regression analysis, the parameter estimates (coefficients) will provide the degree of impact of AUM on Yield under the conditions of three different level of Overall COIS.

12. The method of claim 8, further comprising regression analysis by using investment return as dependent variable; years of experience, Component COIS1 and Component COIS2 as independent variable, the significant of the coefficients will identify the relevant factors contributing to manager performance.

13. A Conflict of Interest (COI) system for selecting investment manager and investment process comprises hardware: input and output devices, memory, processor; and software: spread sheet, database applications, regression analysis package and operating system.

14. The method of claim 13, wherein the spread sheet is used to compute the Overall COIS according to the Input Check List for each manager.

15. The method of claim 13, wherein the ICL database is populated by the Overall COIS and the MRD from each of the managers.

16. The method of claim 15, wherein the input device is used to enter query and regression analysis commands.

17. The method of claim 16, wherein the processor interprets the command language, searching the database and placing the result on an output device that displays the outcome of the regression analysis.
